(19) United States
(12) Patent Application Publication
(10) Pub. No.: US 2023/0093765 A1
(43) Pub. Date: Mar. 23, 2023

(54) REVIEW PLATFORM AND SERVICE

(71) Applicant: MERIFY, LLC, Portland, OR (US)

(72) Inventor: Greg Gasperin, Portland, OR (US)

(21) Appl. No.: 17/932,998

(22) Filed: Sep. 16, 2022

Related U.S. Application Data
(60) Provisional application No. 63/245,708, filed on Sep. 17, 2021.

(51) Int. Cl. G06Q 10/10

(52) U.S. Cl. CPC G06Q 10/1053

(57) ABSTRACT

Examples are disclosed that relate to a computing platform configured for professional networking in which users may be reviewed on a per-skill basis according to ratings given also on a per-skill basis by reviewers of the user. A combined score for a particular skill of a particular user may be weighted based on information relating to the reviewers of the particular user, including the same skill, related skills, and/or unrelated skills of the reviewers.

### CROSS REFERENCE TO RELATED APPLICATIONS

This application claims priority to U.S. provisional application No. 63/245,708, filed Sep. 17, 2021, the entirety of which is hereby incorporated herein by reference for all purposes.

### BACKGROUND

Various platforms have been developed that enable social networking in a professional context. Some platforms, for example, enable users to advertise credentials and skills (e.g., in the interest of seeking employment), and to endorse coworkers.

### SUMMARY

According to an example, a computing system, upon detecting a condition, obtains one or more ratings of a primary skill of a user. Each of the one or more ratings were made by a respective reviewer. For one or more respective reviewers, the computing system obtains one or more ratings of one or more skills of the respective reviewer. Based at least on the one or more ratings of the primary skill of the user and the one or more ratings of the one or more skills of the respective reviewers, the computing system determines a computed rating (i.e., a combined score) of the primary skill of the user. The condition can include the computing system receiving a new rating of the primary skill of the user, and the computed rating of the primary skill of the user can be determined further based on the new rating of the primary skill of the user.

### BRIEF DESCRIPTION OF THE DRAWINGS

FIG. 1 schematically depicts an example computing system configured to implement a platform for social networking in a professional context.

FIG. 2 depicts an example user interface operable to score various skills of a user of the platform of FIG. 1.

FIG. 3 depicts an example user interface indicating information regarding a potential increase in a skill level.

FIG. 4 schematically depicts an example process for calculating a score of a particular skill of a particular user based on one or more reviews of the skill.

FIG. 5 schematically depicts an example process in which a new review triggers computation of a new score for a user in one or more skills.

FIG. 6 schematically depicts various examples in which a skill score is computed for a user based on review scores provided at different skill levels.

FIG. 7 schematically depicts an example process for calculating a score for a particular skill of a particular user based on one or more reviews of the skill using weighting and vetting.

FIG. 8 schematically depicts an example process in which a new review triggers computation of a new score for a user in one or more skills.

FIG. 9 schematically depicts an example computing system.

### DETAILED DESCRIPTION

Various platforms have been developed that enable social networking in a professional context. One such platform may enable users to advertise credentials and skills, for example as part of seeking employment. Prospective employers and other hiring professionals may then utilize the platform to discover candidates for openings, potentially by searching among the credentials and/or skills advertised by users. Further, platforms designed for professional networking may enable users to endorse coworkers. For example, some platforms may support endorsements in the form of textual reviews of coworkers that typically describe the working relationship between a reviewer and a coworker, and skills demonstrated by the coworker in their time working together.

Existing platforms that support professional endorsements exhibit various drawbacks that can reduce the informational value of endorsements and thus the confidence that others such as prospective employers and other hiring professionals may have in these endorsements. One such drawback is a lack of verification that a reviewer endorsing a user had an established professional relationship with the user, or a lack of verification that the reviewer is qualified themselves in the very skills, credentials, or other qualities they are endorsing. Generally, there exists an undue freedom with which a reviewer may endorse users, which may be adversely affected by personal relationships and other factors that are not germane to those users' actual skills or qualifications. Another drawback posed by existing platforms configured for professional networking includes a tendency—which may arise from a lack of support for the ability to granularly endorse individual skills—for users to be reviewed as being equally talented at different skills. In existing platforms, a senior level software engineer may be considered at a senior level at every listed skill, for example, when the software engineer may in fact be at different levels for different skills. Further, existing platforms typically require that users manually update their profiles, which may result in a failure to capture changes that occur such as those due to career advancement, leading to outdated profile information. Still further, existing platforms may exhibit a lack of anonymity—for example, the author of an endorsement and the contents of the endorsement may be fully visible to the user who received the endorsement. Such lack of anonymity discourages transparent, honest reviews of other users.

Existing platforms for professional networking may also fail to support meaningful comparisons among users. For example, some platforms merely enable a binary indication (e.g., yes/no) of whether a user possesses a skill, which fails to communicate the level of aptitude in that skill. Other platforms support text-based reviews that provide qualitative, but not quantitative, information. These and other aspects of existing platforms that exhibit a lack of quantitative information render meaningful comparisons among users difficult or impracticable.

Accordingly, examples are disclosed that relate to a platform configured for professional networking in which users may be reviewed on a per-skill basis according to scores given also on a per-skill basis by reviewers of the user. As described below, the reviewer scores given to a particular skill of a particular user may be weighted based on information relating to the reviewers of the particular user, such as scores received by those reviewers for skills (e.g., secondary skills) other than the particular skill, and scores received by those reviewers for the skills for which they review the particular user. As such, reviewer scores of users may be valued according to the credibility of those reviewers as assessed through scores given by and/or received by the reviewers. Other types of weighting may be applied to review scores to account for their age and statistical relation to other review scores. Further, as new reviews containing new scores are received for users, scores provided by those users regarding skills of other users may be automatically updated to reflect a more thorough understanding of the actual acumen of those users in the skills they reviewed and their credibility as it is gained over time. Examples are also disclosed in which user skills may be scored at various levels (e.g., beginner, intermediate, advanced, expert, etc.), with score computation being adjusted depending on the level in which a skill is scored. This may enable reviewers to review users at levels different than those at which the users view themselves, and for users to view how they may be scored at different levels without requiring further input from those users or their reviewers. As such, opportunities may be identified in which a user may advance levels in a skill yet remain highly scored in that skill, which may support career advancement and skill development. Mechanisms are also disclosed for vetting reviews for the purpose of assessing the quality and credibility of those reviews.

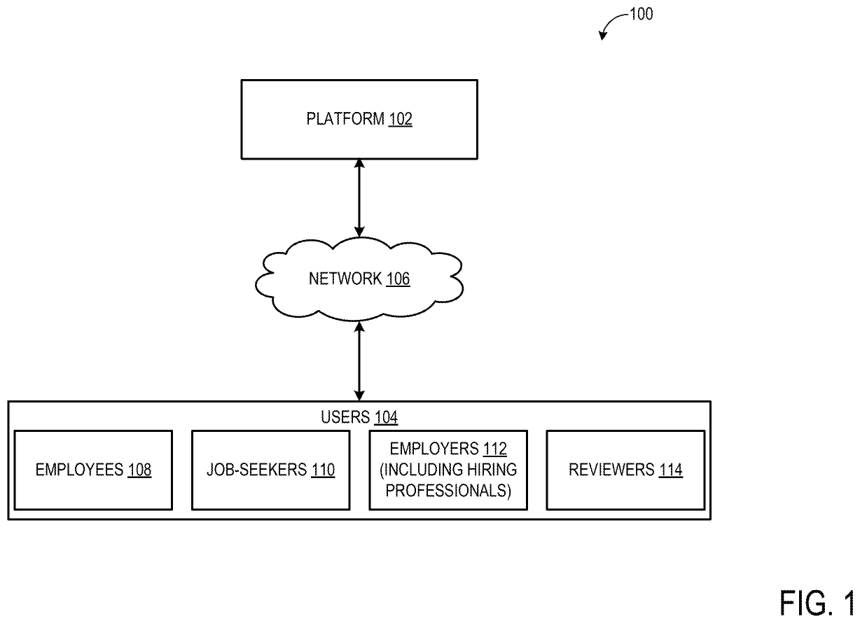

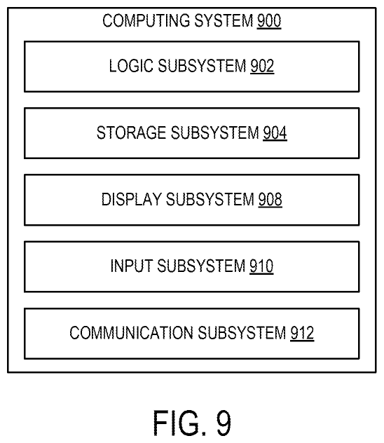

FIG. 1 schematically depicts an example computing system 100 configured to implement a platform 102 for social networking in a professional context. Platform 102 is accessible by users 104 via a network 106, which may include any suitable type of network connection such as an intranet or internet connection. Platform 102 may be hosted by a computing system remote from users 104, who may access the platform via a dedicated application for accessing the platform, an internet browser, and/or any other suitable mechanism. Example hardware that may be implemented by the remote computing system and computing devices utilized by users 104 to access platform 102 is described below with reference to FIG. 9.

Any suitable type of user 104 may access platform 102. As examples, FIG. 1 depicts, among users 104, employees 108 of companies, organizations, and/or other institutions who may access platform 102 for the purpose of maintaining a user profile reflecting their professional experience and skills, with or without the intention of seeking a change in employment. Among users 104 are also job-seekers 110 seeking employment who may not already be employed, and employers 112 (including other hiring professionals) that employ one or more employees and may access platform 102 to search for prospective candidates (e.g., for openings that may be advertised on the platform). Finally, also among users 104 are reviewers 114 who provide reviews of users 104 that include scores of various user skills, as described in further detail below. It will be understood, however, that any suitable type of user may access platform 102, whether they seek employment, review other users, advertise job openings and/or other opportunities, search through platform 102, network with other users, and/or engage with the platform in any other manner. Other types of users include but are not limited to headhunters, recruiters, and government officials. Some users may fall into two or more of the employee, job-seeker, employer (including other hiring professionals), and reviewer categories—for example, a user 104 may be both an employee 108 and an employer 112. Further, the techniques described herein may be applied to platforms configured for uses other than professional networking, including but not limited to classified advertisement, product and/or service reviews, and decision making processes where the input of relatively more qualified individuals—as related to the subject at hand—is considered more relevant than the input of relatively less qualified individuals.

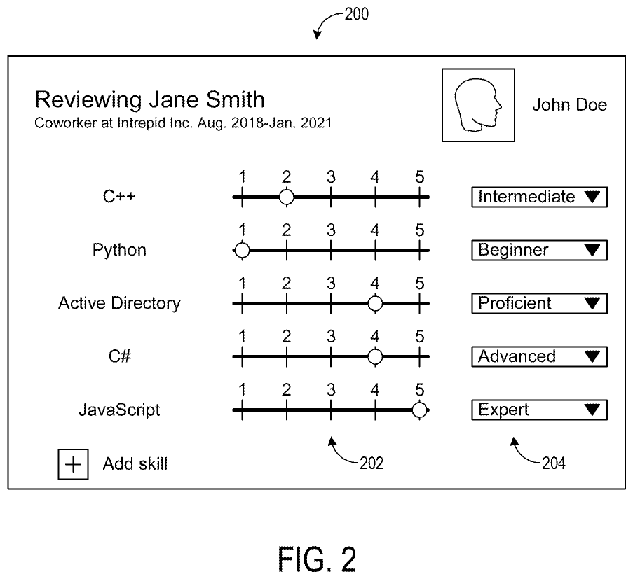

FIG. 2 depicts an example user interface (UI) 200 used by a reviewer to score various skills of a user 104 of platform 102. UI 200 may be presented via execution (e.g., on a computing device local to the reviewer) of a dedicated application configured to support interaction with platform 102, or via execution of an internet browser, as examples. In this example, the reviewer provides, via controls 202, scores each representing the proficiency of the user in a corresponding software-related skill, such as a programming language. Each score is of the form of an integer that can take on one of five possible values (1, 2, 3, 4, 5), with higher scores representing greater proficiency in their corresponding skills. The scores described herein, however, may assume any suitable number and form, including that of a qualitative description selected from a plurality of qualitative score levels (e.g., “novice”, “skilled”, “experienced”, “senior”). Further, each score is provided at a corresponding skill level such that each score assesses the user's proficiency in a corresponding skill at that skill level. In this example, skill levels are selected via controls 204, with each skill level being selected from five qualitative skill levels (e.g., “beginner”, “intermediate”, “proficient”, “advanced”, “expert”). As another example, each skill level can be selected from four qualitative skill levels (e.g., “beginner”, “intermediate”, “advanced”, “expert”). Skill levels may assume any suitable number and form, however, including that of a numerical value selected from a plurality of numerical skill levels.

The skill level selection feature illustrated in FIG. 2 enables reviewers to granularly assess a variety of user skills without requiring that users be assessed as equally proficient across the variety of skills. This feature also enables reviewers to assess user skill from a perspective that may differ from the perspective from which users view their own skills. However, a skill score at a skill level established by a reviewer may be translated to a different skill level through which a user views themselves. As such, the informational value provided by the reviewer may be used to inform an overall assessment of a user's skill, even with the potential disparity in perceived skill level between reviewer and user. As described below, translating a skill score from a higher skill level to a lower skill level may include increasing the skill score, while translating a skill score from a lower skill level to a higher skill level may include decreasing the skill score. Users may establish their own skill levels in various skills via a UI configured similarly to UI 200, for example. Other information, including but not limited biographical data and career information, may be entered by users as part of establishing a user profile.

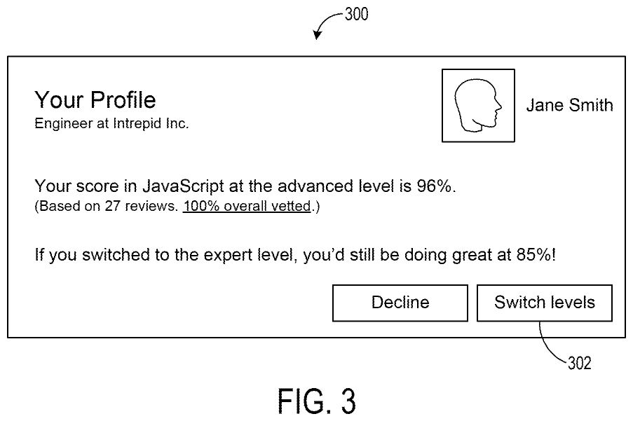

As one example illustrating score adjustment for changes in skill level, FIG. 3 depicts an example UI 300 indicating information regarding a potential increase in the skill level of a user's aptitude in a programming language. In this example, the user has received a plurality of ratings (e.g., based on 27 reviews) for their skill in the programming language, resulting in a combined score of the plurality of ratings in the programming language, expressed as a percentage (96%). As an example, the combined score can be based, at least in part, on an average of the plurality of ratings identified by the reviews. As described in further detail herein, the plurality of ratings can be adjusted through weighting prior to being combined to obtain the combined score. Here, a score of 0% corresponds to a minimum possible aptitude in a skill, and a score of 100% corresponds to a maximum possible aptitude in a skill. The score for the user's aptitude in the programming language is computed at an “advanced” skill level. UI 300 notifies the user that, were they to advance their skill level in the programming language from the advanced level to a higher “expert” level, they would retain a high score (85%) at the expert level. To this end, UI 300 includes a control 302 operable to effect this increase in skill level.

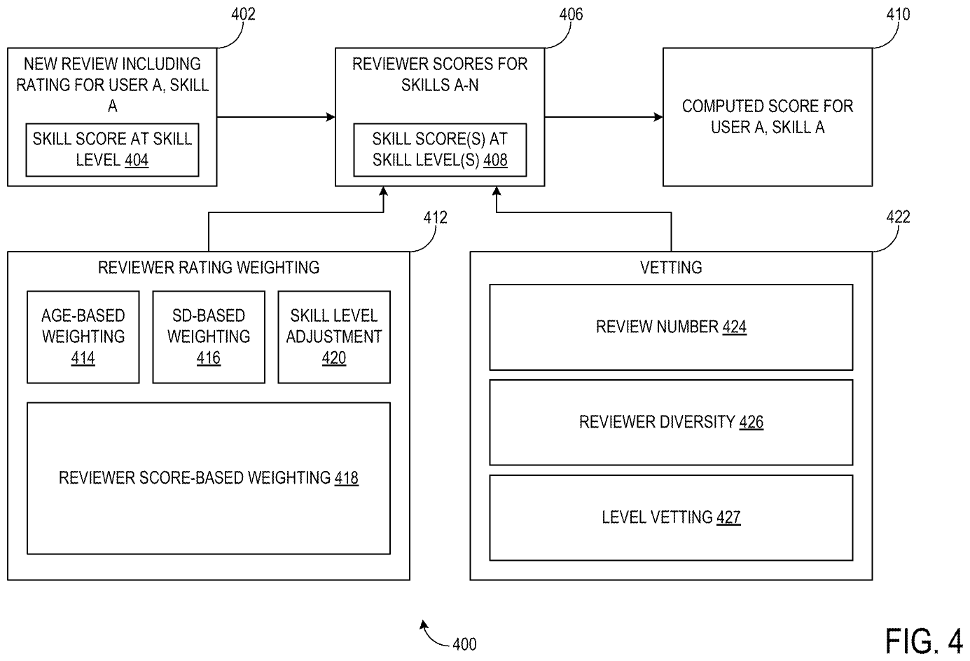

FIG. 3 represents examples in which platform 102 may push notifications to users suggesting advancements in skill levels when opportunities to advance skill level are identified that still produce high scores after advancement. This feature may aid in nurturing career development and advancement by automatically identifying such opportunities and suggesting skill level adjustment, without requiring that users manually intervene to explore level adjustment. Alternatively or in addition to pushing notifications of opportunities for skill level adjustment, users may be afforded the ability (e.g., through UI 300 or another UI) to query platform 102 regarding a skill level adjustment and obtain the resultant score in the corresponding skill that would result were such level adjustment to take place. This feature may encourage professional development and users to maintain up-to-date profiles that accurately reflect their skills. Further, as described below with reference to FIG. 4, changes to a user's skill level may affect how that user is vetted.

It will be understood that the techniques described herein may apply to scoring or otherwise reviewing aspects of users other than their skills, including but not limited to education and other professional or life experience, activities, memberships, licenses, certifications, and other accomplishments. Thus, as used herein, “skill” may refer to one or more of these and/or other potential aspects regarding a user that can be scored or otherwise reviewed.

Furthermore, within the present disclosure, two or more skills can be grouped within the framework of the system such that a particular skill is considered related to one or more other skills that are grouped together in the same skill group. Two or more skills are considered unrelated if those skills are not grouped together in the same skill group. As described in further detail herein, a rating or score assigned to a skill for a particular user can be weighted based on a rating or score assigned to related or unrelated skills of the user.

FIG. 4 schematically illustrates an example process 400 for calculating a score of a particular skill of a particular user based on one or more reviews of that user's skill. The user being reviewed may be an employee 108 and/or job-seeker 110, with each review being provided by a corresponding reviewer 114, as examples.

As indicated at 402, in this example, a new review for a user A and a skill A are received (e.g., at platform 102). As indicated at 404, the review includes a score rating the user A in skill A, for a particular skill level. As indicated at 406, this new score is combined with prior scores given by one or more reviewers who have previously reviewed user A for skill A. As indicated at 408, each review provided by a reviewer includes one or more skill scores each at a corresponding skill level. These reviewer scores may include scores given by the reviewers to user A for skill(s) (e.g., secondary skills) other than skill A. Alternatively or additionally, the reviewer scores may include scores given by the reviewers to other users for skill(s) (e.g., secondary skills) other than skill A. Further, in some examples, the new score received at 402 may be combined with the scores given by all of the reviewers who have reviewed user A for skill A. As described below, reviewer scores may be combined with the new score received at 402, and one or more prior scores given to user A in skill A to ultimately determine a new score for user A in skill A that accounts for the new score, as indicated at 410.

As indicated at 412, the reviewer scores combined with the new score received at 402 may be weighted based on various criteria. As indicated at 414, one such criterion may include an age of a score, such that the score is decreasingly weighted as the score increases in age. In this approach, older scores may be regarded as having less informational value and relevance than newer scores, as newer scores may be more likely to accurately reflect a user's skill set as it exists currently. The age-based score weighting indicated at 414 may be implemented in any suitable manner. For example, the age of a score may be placed within one of a plurality of age ranges and weighted according to the range in which the age falls. As a particular example, age ranges in which scores may be sorted may include an age of one year and/or the current year, an age of two years, an age of three years, an age of four years, an age of five years, an age of six to ten years, and an age of greater than ten years. In some examples, scores with an age older than a threshold age (e.g., greater than ten years) may be weighted at zero and accordingly discarded from the process of calculating a computed score at 410. As another particular example, the age-based weighting process may associate a corresponding integer with each age range, and a corresponding weight with each integer, with the weight being applied to scores that fall within the corresponding age range.

The age of a score may be calculated in any suitable manner. In some examples in which a reviewer provides a score for a user with which the reviewer worked, or established another professional relationship, the age may be calculated based on when the professional relationship between the user and reviewer was last current. Where the reviewer and user currently have an existing professional relationship, such as being employed by a common employer, the age of a score may be computed as the time (e.g., in years) between the date the review was provided and the current date. Where the reviewer and user had a professional relationship that ended (e.g., either or both the reviewer and user left a common employer), the age of a score may be computed as the time between the last date at which the reviewer and user still had an existing professional relationship and the current date. In service of determining the age of scores from the duration of professional relationships, platform 102 may host or access data (e.g., human resource information) regarding such professional relationships.

Reviewer scores alternatively or additionally may be weighted based on their statistical properties relative to other reviewer scores. For example, as indicated at 416, scores may be weighted according to their standard deviation relative to other scores. As with score age, in some implementations, scores may be placed within one of a plurality of standard deviation ranges and weighted according to the standard deviation range in which they fall. As one particular example, scores with standard deviations of less than one may be highest weighted, of less than two may be relatively less weighted, and of greater than two minimally weighted. In such approaches, scores with higher standard deviations may be weighted relatively less as such scores may be regarded as outliers or less informative than scores with lesser standard deviations, which may be regarded as more credible and informative.

Reviewer scores alternatively or additionally may be weighted based on scores those reviewers have received themselves, as indicated at 418. Where a reviewer has been scored themselves in a skill that the reviewer scores for another user, the score given by the reviewer to that skill may be weighted more heavily based on the score the reviewer has received in that skill than scores the reviewer has received for other skills (e.g., secondary skills). As a particular example in which the reviewer is rated themselves in the skill for which the reviewer is scoring for another user, the weight applied to the reviewer score may be computed as 80% of the reviewer score in that skill, and as 20% of the reviewer score(s) in other skills (e.g., secondary skills). This computation may yield a percentage that is then mapped to one of a plurality of integers, with the selected integer being used to weight the score given by the reviewer to the skill they are reviewing. As one example, the percentage may be mapped to an integer selected from one to ten (inclusive). Where a reviewer is highly rated in the skill they are reviewing, and is highly rated in other skills (e.g., secondary skills), the weighting applied to the score given by the reviewer may be ten, for example. Where a reviewer is instead highly rated in the skill they are reviewing, but poorly rated in other skills (e.g., secondary skills), the weighting applied to the score given by the reviewer may be eight or nine, for example.

Where a reviewer has not been rated in the skill the reviewer is scoring in another user, the reviewer's own scores may be averaged with equal weighting to determine a final weight to apply to the score given by the reviewer to the skill. This may yield a percentage that is then mapped to one of a plurality of integers (e.g., one to seven, inclusive), with the selected integer being used to weight the score given by the reviewer to the skill they are reviewing. Where a reviewer instead has not been rated in any skill, a minimum weight may be applied to the score given by the reviewer to a skill of another user.

The score-based weighting of reviewers described above may help increase the informational value of reviews, as scores received by the reviewers themselves—particularly in the very skills the reviewers rate in others—may serve as a highly informative indication of reviewers' own aptitudes, and thus the extent of their credibility in scoring others.

As described above, a reviewer may score a user skill at a skill level that differs from the skill level at which the user being reviewed assesses their own skill. As indicated at 420, a reviewer score provided at one skill level may be translated to another skill level established by the user being reviewed. Score translation may be implemented in any suitable manner. In some examples in which scores are expressed as percentages, translation of a score among skill levels may include increasing the percentage where the score is translated from a higher skill level to a lower skill level, and decreasing the percentage where the score is translated from a lower skill level to a higher skill level. As a particular example, a decrease of a single skill level may apply a 10% increase to a score, a decrease of two skill levels may apply a 20% increase to a score, a decrease of three skill levels may apply a 30% increase to a score, and a decrease of four skill levels may apply a 40% increase to a score. As another particular example, an increase of a single skill level may apply a 10% decrease to a score, an increase of two skill levels may apply a 20% decrease to a score, an increase of three skill levels may apply a 30% decrease to a score, and an increase of four skill levels may apply a 40% decrease to a score. As yet another particular example, a review of a single skill that represents a decrease of one or more levels from the user's self-assigned level for that skill may be translated to the lowest possible percentage score at that self-assigned level. Similarly, a review of a single skill that represents an increase of one or more levels from the user's self-assigned level for that skill may be translated to the highest available percentage score at that self-assigned level. Any suitable adjustments to scores for skill level changes may be implemented, however, and in any suitable manner.

In some examples, a user's proficiency in a skill may be vetted based on various criteria, as indicated at 422. This may produce an indication of whether the skill is vetted—i.e., a binary indication of vetted/not vetted—and/or a degree to which the skill is vetted (e.g., as expressed by a percentage). The vetting of a skill may affect how the skill is presented when searched for using platform 102. For example, where the skill is not vetted, the skill may not be presented, for example when searching for that skill among a pool of users or when accessing a user profile of the user possessing the skill. In other examples, the skill may be presented along with an indication of whether the skill is vetted and/or a degree to which the skill is vetted. Further, information regarding the vetting of a user's skills may be presented to the user, which may help motivate users to improve their skills and their resultant visibility in searches. In some examples, vetting may be applied to reviewers who provide reviews of other users, such that the vetting of reviewers' own skills may affect the weighting of scores provided by those reviewers, and/or whether or not those scores are considered in computing a score for a user.

The vetting of a skill may consider the number of reviews that skill has received, as indicated at 424. In some examples, whether a skill is vetted may depend on the skill level at which that skill is assessed. As an example in which user skills are assessed at four skill levels, a skill may be vetted at the lowest level if the skill has received three or more reviews, at the next lowest level if the skill has received six or more reviews, at the next lowest level if the skill level has received nine or more reviews, and at the highest level if the skill has received twelve for more reviews. Thus, in some examples in which a user adjusts their skill level in a skill, either through manual adjustment or suggestion by platform 102, their vetting in that skill may change. For example, a user vetted at an advanced level in a skill may be no longer vetted upon advancing to a relatively higher expert level in the skill, as a relatively greater number of reviews may be required to be vetted at the expert level than at the advanced level. Alternatively or additionally, a skill may be vetted based on the number of years the skill has been demonstrated or practiced, where the number may vary with skill level.

The vetting of a skill alternatively or additionally may consider the diversity of the reviewers who reviewed that skill, as indicated at 426. For example, a percent vetted may be determined for a skill by calculating the following: R=N_{RoR}/N_{DR}, where N_{DR} is the number of direct reviewers who have directly reviewed the skill, and N_{RoR} is the number of reviewers who have reviewed the direct reviewers. The calculation of R may be followed by calculating the following: min(R, 2.5)/2.5. The result of this calculation may then be mapped to a range (e.g., [0.5, 1], inclusive) to determine a percent vetted for the skill. In some examples, if R is less than a threshold (e.g., 2.5), the user may be considered as not being vetted in that skill. In other words, such examples may stipulate that R pass the threshold for the skill to be vetted. Vetting based on review/reviewer diversity in this manner may help filter out fraudulent, biased, or otherwise low-value information from factoring into skill score calculations, as more diverse information may be likelier to have informational value. This may be achieved without taking invasive measures to verify reviews that dissuade users from using platform 102.

The vetting of a skill alternatively or additionally may stipulate that a user receive a minimum number of reviews assessing the user at or above the skill level at which the user assesses themselves, as indicated at 427. Such level vetting may be implemented in any suitable manner. In some examples, the last n reviews a user has received, where n is an integer (e.g., 10), may be considered based on their effective review dates. The user may be considered vetted if a threshold percentage/amount (e.g., 50%) of those reviews placed the user at or above the level the user placed themselves. Otherwise, the user may be considered not vetted. In some examples, the threshold percentage/amount may vary with skill level, such that, for a higher skill level, a relatively greater number of reviews assessing the user at or above that skill level may be required than the number of reviews required for a lower skill level. Further, in some examples, information regarding vetting may be presented to the user—as an example, FIG. 3 depicts a percentage vetted in UI 300 for the depicted user. Here, an overall vetted percentage is depicted, which may be computed as an average of one or more of (1) the review number vetting metric described above with reference to 424, (2) the reviewer diversity vetting metric described above with reference to 426, and (3) the level vetting metric described above with reference to 427. In some examples, a user may be afforded the ability (e.g., through selection of the percent vetted in UI 300) to view how an overall vetted percentage is computed, and potentially the values of the individual vetting metrics factoring into such computation, so as to gain insight into this computation as well which potential actions the user may take to raise the computed value. Level vetting of this type may address scenarios where there is a significant disparity between the skill level at which a user assesses themselves and the skill level(s) at which reviewers assess the user—e.g., where the user views themselves at an expert level in a skill, but all reviews for the skill are assessed at a beginner level. Applying level vetting to this type of scenario may lead to the user being vetted as a beginner, rather than being treated as a very lowly rated expert in the skill.

In some examples, the weighting applied to a reviewer's scores, given by the reviewer to one or more users in one or more skills, may be affected by whether the reviewer is vetted in the skills they score. In such examples, where the reviewer is vetted in a skill the reviewer scores for other user(s), the score(s) given by the reviewer in that skill may be weighted more heavily and thus have a relatively greater impact in subsequent calculations, as compared to where the reviewer is not vetted in the skill.

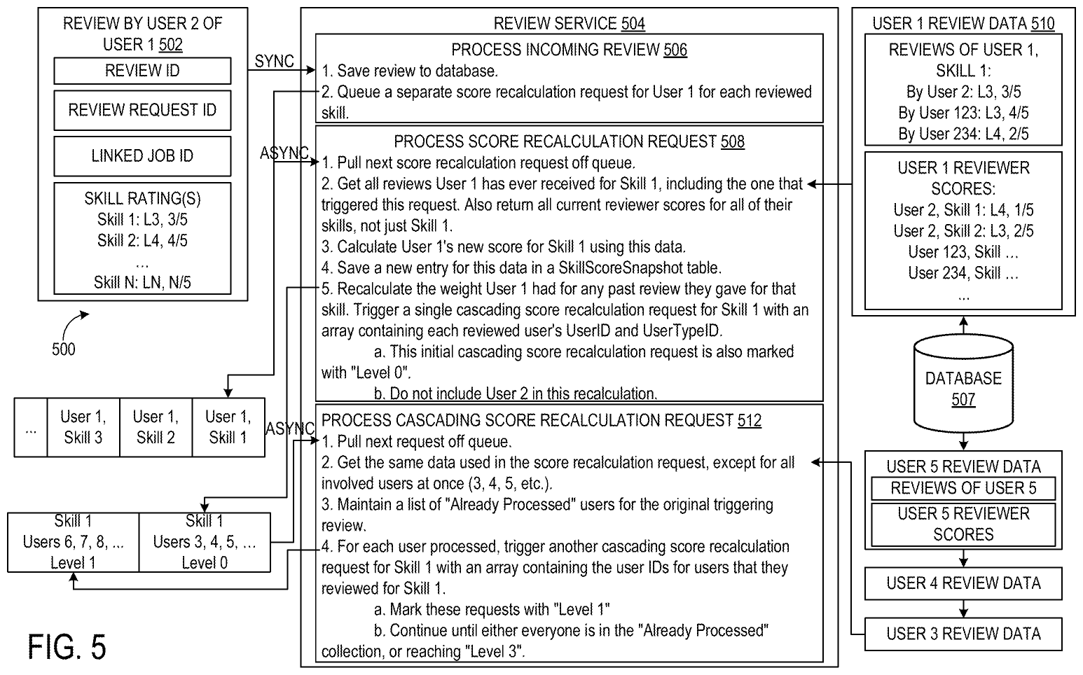

FIG. 5 schematically depicts an example process 500 in which a new review 502, including a score for a particular user (e.g., User 1) in a particular skill, triggers computation of a new score for the user in the skill, as well as downstream computations regarding scores the user has previously made for other users. New review 502 can be obtained synchronously with submission by a reviewer (e.g., User 2) as depicted schematically in FIG. 5. New review 502 may include various other data such as a review ID, a review request ID, a linked job ID, etc. The linked job ID may be used to verify that a professional relationship exists or used to exist between the reviewer who provided the new review and the particular user being reviewed. In some examples, periodic checks to verify professional relationships may be performed, for example on a randomized basis.

New review 502 is received at a review service 504, which, as indicated at 506, is saved to a database 507, though any other suitable type of storage may be used to store reviews. A score recalculation request for the user is then queued for each skill for which they have been reviewed. The score recalculation request can be queued and processed asynchronously as indicated schematically in FIG. 5. As indicated at 508, the score recalculation request is then processed. As indicated at 510, this includes retrieving all the reviews the particular user has received for the particular skill, including new review 502, which in this example triggered the score recalculation request. As also indicated at 510, processing of the score recalculation request may also include retrieving scores received by one or more reviewers who have reviewed the particular user, which may include scores for skills other than the particular skill for which the new score is being computed. As described above, reviewers' own scores may be used to weight scores those reviewers provided regarding the particular user.

Based on the review data indicated at 510, a new score for the particular user in the particular skill is calculated, which may be stored in a snapshot table or other data structure. Generally, snapshots may be created for various data (e.g., scores) used in the computations performed by review service 504 so as to mitigate repeated access to data (e.g., large volumes of reviews) that may incur a high computational expense. Following calculation of the new score for the particular user in the particular skill, the weight applied to scores given by the user in reviewing others for the particular skill may then be recalculated by triggering a cascading score recalculation request for the skill. This recalculation process omits the reviewer who provided new review 502.

As indicated at 512, the cascading score recalculation request includes retrieving the request from a queue or other data structure, and retrieving the same data used in the score recalculation request, with the exception that data is retrieved for all implicated users—e.g., those users who the particular user has reviewed—simultaneously (e.g., by retrieving one or more snapshots). This approach enforces a deterministic order in which users are processed and thus a deterministic result, whereas different results may be obtained were different users to be processed in different orders. A list may be maintained of users who have already been processed for the original triggering review, and for each user processed, another cascading score recalculation request may be triggered for the particular skill. This may utilize an array including user IDs for users that were reviewed for the particular skill.

The score recalculation processes illustrated in FIG. 5 enables scores provided by a reviewer to be retroactively adjusted as new data is received regarding the reviewer that better informs an understanding of the reviewer, such as their credibility and expertise as assessed through their own scores they have received. According to this approach, review service 504 may provide results that are “eventually correct”—weights and resultant scores may be calculated as new data such as a new review is received, which may prompt the recalculations described above. As such, review service 504 may function as a self-correcting system in this sense. Alternative or additional triggers for score calculation/recalculation are possible, however, including the expiration of a threshold duration, which may result in periodic score computations. The cascading score recalculation request can be processed asynchronously as depicted schematically in FIG. 5.

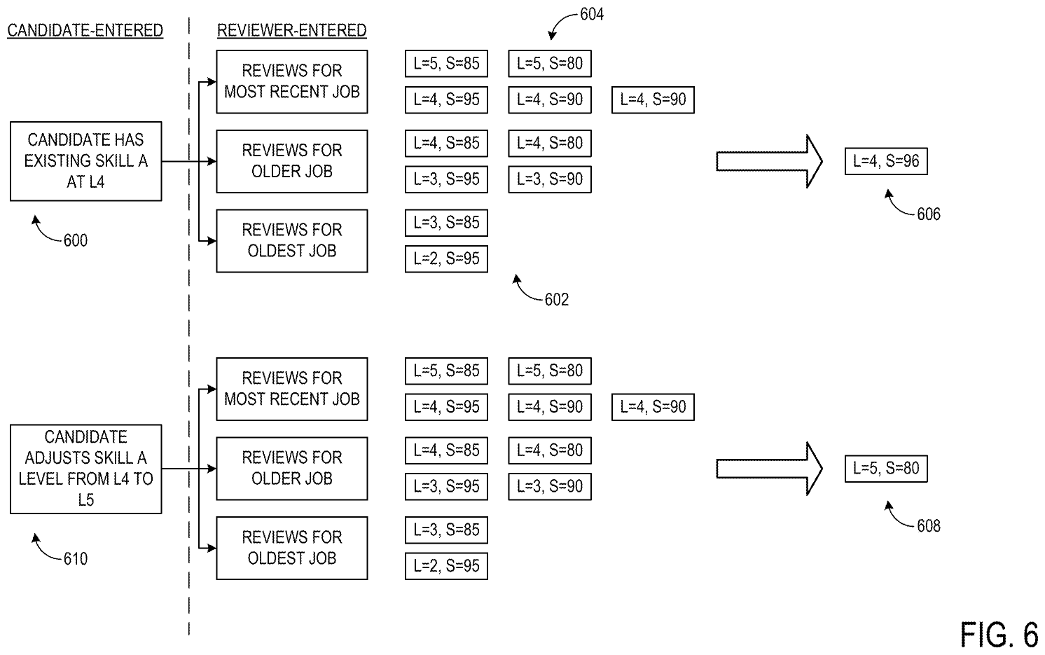

FIG. 6 schematically illustrates various examples in which a skill score is computed for a user based on review scores provided at different skill levels. As indicated at 600, in this example, the user has an existing skill that the user has assessed at a particular skill level (a skill level of four out of five, in this example). To compute a score for this skill, reviews from the most recent job of the user, a relatively older job of the user, and an oldest job of the user, are utilized. As indicated at 602, the reviews include scores for the skill provided at various different skill levels. FIG. 6 illustrates how scores may be adjusted for a skill level change—for example, as indicated at 604, a score—expressed as a percentage—may be increased by 10% when the score is translated to the next lower skill level, and may be decreased by 10% when the score is translated to the next higher skill level. Any suitable type of score adjustment may be implemented for skill level changes, however. The various review scores depicted in FIG. 6 are used to compute an overall score for the skill, which as indicated at 606, is 96% at a skill level of four out of five. As indicated at 608, the score for this same skill is 80% at a skill level of five out of five (i.e., a maximum skill level). FIG. 6 also indicates, at 610, a potential trigger for computing the new score for the skill, which includes the user advancing the skill level of this skill by one level. In this example, this adjustment also results in a score for the skill of 80% at the highest skill level. It will be understood that FIG. 6 is presented as an example, and that, in other examples, all reviews a user has received for a skill, and potentially for all jobs worked by the user, may factor into computing a score for that skill, as opposed to a subset of reviews the user has received for the skill.

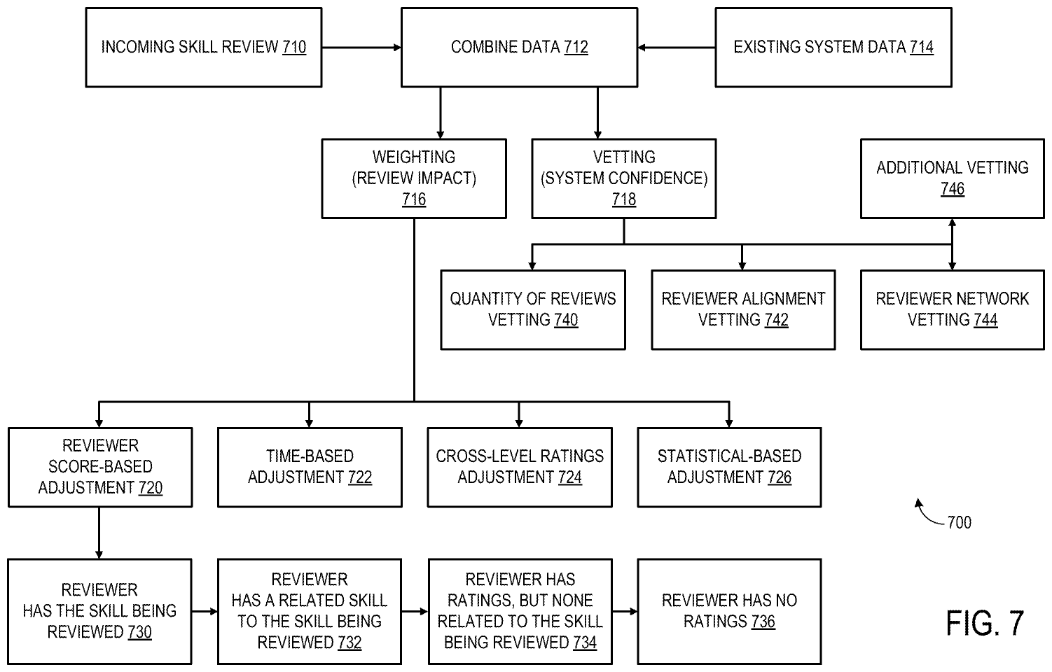

In the preceding example of FIG. 4, weighting can performed at operation 412 and vetting can be performed at operation 422. FIG. 7 is a flow diagram depicting a process 700 of additional examples of weighting and vetting that can be performed by the system disclosed herein. The additional examples of process 700 can be used in place of or in combination with the previously described weighting and vetting examples of FIG. 4.

At 710, an incoming review (e.g., Review 1) is obtained by the system with respect to a target user (e.g., User 1) for a skill (e.g., Skill 1) as provided by a reviewer (e.g., Reviewer 1). The review received at 710 can indicate or otherwise identify a new rating that identifies rating value (e.g., Value 1) for a skill level (e.g., Skill Level 1) with respect to the skill for the target user as assigned by the reviewer. As an example, the rating value can take the form of a numerical value (e.g., an integer of 1 through 5) or a text-based value (e.g., low, medium, high); and the skill level can be one of a plurality of predefined skill levels (e.g., beginner, intermediate, advanced, expert). In at least some examples, the rating value can be converted to a numerical value within a value range, such as a percentage between 0% through 100% or other suitable value range. Accordingly, for each review obtained at 710, the review indicates or otherwise identifies the following information: a review identifier (e.g., for Review 1), a user identifier (e.g., for User 1), a reviewer identifier (e.g., for Reviewer 1), a skill identifier (e.g., for Skill 1), a rating value identifier (e.g., Value 1), and a skill level (e.g., Skill Level 1).

At 712, the review received at 712 is combined with existing system data 714, which can include previous reviews and current ratings for some or all skills for the target user. As an example, the review for User 1, Skill 1 received at 710 can be combined at 712 with the complete set of current ratings by all other reviewers who have reviewed the target user (e.g., User 1) within existing system data 714.

As part of combining the incoming review received at 710 with the existing system data 714 at 712, a weighting of the combined rating for the skill for the target user can be determined at 716 and vetting can be performed at 718.

The weighting determined at 716 can be used to determine a review impact for the review obtained at 710 on the combined rating for the skill. As an example, the weighting determined at 716 can provide a metric that the system considers when determining the impact of a specific review on the target user's combined rating for the skill. The review impact, as expressed by the weighting determined at 716 can take the form of a multiplier, in at least some examples. For example, a review assigned a multiplier of 12 will have twice as much review impact on the combined rating of the target user as a review assigned a multiplier of 6.

As part of determining the weighting for the review at 716, one or more adjustments can be performed, including a reviewer scored-based adjustment 720, a time-based adjustment 722, a cross-level ratings adjustment 724, and a statistical-based adjustment 726, as examples.

Reviewer score-based adjustment 720 can depend on the reviewer's experience with the skill being reviewed or with related skills. Different score-based adjustments can be performed at 720 depending on the reviewer's experience with the same skill being reviewed or a different, but related skill to the skill being reviewed. Skills that are related or unrelated to the skill being reviewed can also utilize different score-based adjustments as described in further detail below.

Reviewer score-based adjustment 720 can include one or more of sub-processes 730, 732, 734, 736. In at least some examples, the system performs these sub-processes in the following sequence 730, 732, 734, 736 as schematically indicated by the logic flow of FIG. 7; and does not perform a subsequent sub-process in the sequence if criteria for the preceding sub-process is satisfied. In this example, the sequence of sub-processes 730, 732, 734, 736 are ordered based on the reviewer's experience with the skill being reviewed in the review received at 710, a related skill, an unrelated skill, or lack of any skill within the system.

As an example, at 730, the process includes determining whether the reviewer has the skill being reviewed in the review obtained at 710. If the reviewer is determined at 730 to have the skill being reviewed, the review is determined to have the highest potential review impact. For example, a raw impact value can be determined at 730 according to a predefined function, such as 80% of the raw impact value being defined by the rating for the reviewer for the same skill (e.g., Skill 1) as the review, and the remaining 20% of the raw impact value being defined by an average of the other ratings (if any) for the reviewer for some or all other skills. As an illustrative example, if the reviewer has a rating value of 5 for the skill being reviewed for the target user, and the reviewer has an average rating of 3 for the other skills, the raw impact value can be determined as the sum of the product of 5 and 0.80 and the product of 3 and 0.20, which is equal to 4.6 in this example. In at least some examples, the raw impact value can be mapped to a reviewer score-based adjustment value within a predefined range—e.g., 7 through 12 in which 12 represents the highest weighting for review impact and 7 represents the lowest weighting for review impact for sub-process 730 in cases where the reviewer has the skill being reviewed.

Alternatively, if the reviewer is determined at 730 to not have the skill being reviewed by the review received at 710, then the system proceeds to sub-process 732, where the process includes determining whether the reviewer has a related skill to the skill being reviewed in the review for the target user. As previously described, a skill can be associated with related skills as part of a skill group. As an example, if the reviewer has a skill related to the skill being reviewed in the review (e.g., a skill in the same skill group), the review can have the second-highest potential review impact. In cases where the reviewer has multiple skills related to the skill being reviewed, the related skill with the highest raw impact score can be used to determine the weighting for the review impact in sub-process 732. As an example, for each related skill, the raw impact value can be determined as the sum of the product of the rating value for related skill for the reviewer and 0.80 and the product of the average value for some or all other skills for the reviewer and 0.20. In at least some examples, the highest raw impact value among related skills of the reviewer can be mapped to a reviewer score-based adjustment value within a predefined range (e.g., 4 through 7) which is lower that the predefined range used at sub-process 730.

Alternatively, if the reviewer is determined at 732 to not have any related skills to the skill being reviewed by the review obtained at 710, then the system proceeds to sub-process 734 where the process includes determining whether the reviewer has one or more ratings for one or more unrelated skills—i.e., none of the ratings for the reviewer are for skills related to the skill being reviewed in the review obtained at 710. If the reviewer has ratings for one or more unrelated skills, then the review received at 710 can be assigned the third-highest potential review impact value. In this example, the raw impact value can be defined as the average of the rating values assigned to the unrelated skills. In at least some examples, the review impact value can be mapped to a reviewer score-based adjustment value within a predefined range (e.g., 2 through 4) which is lower that the predefined range used at sub-process 732.

Alternatively, if the reviewer is determined at 734 to not have a rating for any skill, the review impact value can be defined at 736 to have a reviewer score-based adjustment value of 1.0 or other suitable value that is less than the predefined range used at sub-process 734.

Time-based adjustment 722 can include assigning a weighting that is based on an age or recency of the review to account for career growth over time. As examples, a review that is less than or equal to 1 year old can be assigned a weighting of 20, less than or equal to 2 years old can be assigned a lesser weighting of 19, less than or equal to 3 years old can be assigned a lesser weighting of 17, less than or equal to 4 years old can be assigned a lesser weighting of 14, less than or equal to 5 years old can be assigned a lesser weighting of 11, less than or equal to 6 years old can be assigned a lesser weighting of 7, less than or equal to 7 years old can be assigned a lesser weighting of 2, and greater than 7 years old can be assigned a lesser weighting of 0.

Cross-level ratings adjustment 724 can include determining whether the review obtained at 710 identifies a skill level that is lower than, equal to, or greater than the skill level that was self-assessed by the target user being reviewed. As an example, if the skill level identified by the review is equal to the skill level that was self-assessed by the target user, no adjustment to the rating is performed at 724.

If the skill level identified by the review is greater than the skill level self-assessed by the target user (e.g., advanced is greater than intermediate), the highest rating for the self-assessed skill level can be used in place of the rating identified by the review. As an example, if the self-assessed skill level by the target user is “intermediate”, and the review identifies a skill level of “advanced” that is greater than the self-assessed skill level of “intermediate”, the rating is set to the highest rating (e.g., 5 out of 5) in the self-assessed skill level despite a lower rating (e.g., 1-4 out of 5) being identified by the review.

If the skill level identified by the review is less than the skill level self-assessed by the target user (e.g., advanced is less than expert), the lowest rating for the self-assessed skill level can be used in place of the rating identified by the review. As an example, if the self-assessed skill level by the target user is “advanced”, and the review identifies a skill level of “intermediate” that is less than the self-assessed skill level of “advanced”, the rating is set to the lowest rating (e.g., 1 out of 5) in the self-assessed skill level despite a higher rating (e.g., 2-5 out of 5) being identified by the review.

Cross-level ratings adjustment 724 enables reviewers to rate a target user independently of that user's self-assessment, and reduces or prevents self-assessments from influencing reviewer ratings. Additionally, cross-level ratings adjustment 724 can also allow for self-assessments to change over time without reviewers having to resubmit or change their prior reviews.

Statistical-based adjustment 726 can include determining a standard deviation or other suitable statistical metric to reduce the impact of outlier ratings by reviews on the combined rating for the target user. As an example, if the rating identified by the review obtained at 710 is within or equal to one standard deviation from the other ratings for the skill, a weighting of 4 can be applied at 726. If the rating is between one and two standard deviations or equal to two standard deviations from the other ratings for the skill, a weighting of 2 can be applied at 726. If the rating is beyond two standard deviations from the other ratings for the skill, a weighting of zero can be applied at 726.

The weighting determined at each of adjustments 720, 722, and 726 can be summed to obtain a combined weighting for review impact that is applied to the adjusted rating obtained by cross-level adjustment at 724 to obtain a weighted rating for the skill. As an example, the combined weighting from 720, 722, and 726 can be applied to the adjusted rating obtained from cross-level ratings adjustment 724 as a multiplier to obtain the weighted rating for the skill. For example, reviewer score-based adjustment 720 can assign a weighting of 12, time-based adjustment 722 can assign a weighting of 20, and statistical-based adjustment 726 can assign a weighting of 4 to obtain a combined weighting of 36. This combined weighting of 36 can be multiplied by the adjusted rating (e.g., 1-5 out of 5) obtained from cross-level ratings adjustment 724 to obtain the weighted rating for the skill. The weighted rating obtained by weighting 716 can be combined with other weighted ratings, as previously described, to obtain a score for the skill.

Vetting performed at 718 can be used to determine a system confidence for a combined rating of a skill for a target user. In at least some examples, ratings identified by reviews are made accessible to other users responsive to those ratings being successfully vetted. Vetting metrics can be applied by the system to achieve system confidence in those ratings prior to making the combined rating accessible via the system.

As part of vetting performed at 718, one or more of sub-processes can be performed, including quantity of reviews vetting 740, reviewer alignment vetting 742, reviewer network vetting 744, and additional vetting 746. Vetting can be used by the system to determine whether a score or rating of a skill for a target user is to be published at a network resource (e.g., website or other interface) accessible to other users. As an example, responsive to successful vetting discussed in further detail below, the score or rating for the target user can be published to a network resource where it is accessible to other users of the system. However, responsive to vetting not being successful, the score or rating for the target user can be maintained by the system as not being accessible to other users of the system.

Quantity of reviews vetting 740 can include determining whether a threshold minimum quantity of reviews have been received for a target user on a per-skill basis. In at least some examples, the threshold minimum quantity of reviews can vary based on the skill level of the skill for the target user. As an example, the minimum threshold quantity can be defined as: 3 for beginner, 6 for intermediate, 9 for advanced, 12 for expert. However, it will be understood that other suitable minimum threshold quantities can be used. The target user can be considered vetted for the skill in sub-process 740 if the quantity of reviews for the skill for the target user attains or exceeds the minimum threshold quantity of reviews. As an example, for a skill having an advance skill level, the target user can be considered vetted for the skill upon receiving 9 or more ratings for the skill from reviewers.

Reviewer alignment vetting 742 can include determining whether a threshold minimum quantity of reviewers selected the same skill level or a greater skill level than self-assessed by the target user. In at least some examples, the threshold minimum quantity of reviewers for a skill that identify the same or greater skill level as compared to the self-assessed skill level can vary based on the self-assessed skill level for the target user. As an example, the minimum threshold quantity of reviewers having the same or greater skill level for a skill can be defined as: 2 for beginner self-assessed skill level, 4 for intermediate self-assessed skill level, 6 for advanced self-assessed skill level, 8 for expert self-assessed skill level. However, it will be understood that other suitable minimum thresholds can be used. The target user can be considered vetted for the skill in sub-process 742 if the quantity of reviewers for the skill for the target user attains or exceeds the minimum threshold quantity of reviewers.

Reviewer network vetting 744 can include determining whether the reviewers, for the same skill identified by the review, have a minimum threshold ratio of reviewers. As an example, a first quantity of Level 1 reviewers (i.e., reviewers that submitted a review for the target user) can be determined, and a second quantity of Level 2 reviewers (i.e., reviewers that have submitted a review for the Level 1 reviewers) can be determined. The quantity of Level 2 reviewers can be divided by the quantity of Level 1 reviewers to obtain a result that is compared to the minimum threshold ratio of reviewers. As an example, the minimum threshold ratio of reviewers can be defined as 2, such that the minimum ratio of Level 2 reviewers to Level 1 reviewers is 2:1. However, it will be understood that other suitable minimum thresholds can be used. As an example, the minimum threshold ratio can be defined as being greater than 1.0. The target user can be considered vetted for the skill in sub-process 744 if the result attains or exceeds the minimum threshold ratio of reviewers.

Additional vetting 746 can incorporate the use of one or more additional vetting metrics. As an example, as part of additional vetting 746, reviewer alignment vetting 742 described above can be augmented to consider only reviews having an age or recency that is less than a threshold (e.g., within the past predefined quantity of years) to eliminate older reviews from being considered. Additionally or alternatively, as part of additional vetting 746, reviewer alignment vetting 742 described above can be augmented to implement a minimum ratio threshold on the self-assessed skill level. As an example, the skill level identified by reviewers for a skill can be compared to the self-assessed skill level for the skill to determine whether a minimum threshold ratio (e.g., 80% or other suitable value) of the reviewers identified the same skill level or a greater skill level for the skill within their review for the target user as compared to the total quantity of reviewers for the skill for the target user.

In at least some examples, a target user is considered vetted for a skill if vetting is successfully achieved at each (i.e., all) of sub-processes 740, 742, 744, 746 and is conversely considered to be not vetted if any of sub-processes 740, 742, 744, 746 do not result in vetting. This example provides a higher degree of vetting due, at least in part, to vetting being required for each (i.e., all) of sub-processes 740, 742, 744, 746. However, in other examples, the target user is considered vetted for a skill if vetting is successfully achieved by any one of sub-processes 740, 742, 744, 746, or if two or more or three or more of sub-processes 740, 742, 744, 746 result in vetting. These examples provide a lower degree of vetting as compared to the preceding example due, at least in part, to vetting being required for only a subset of sub-processes 740, 742, 744, 746.

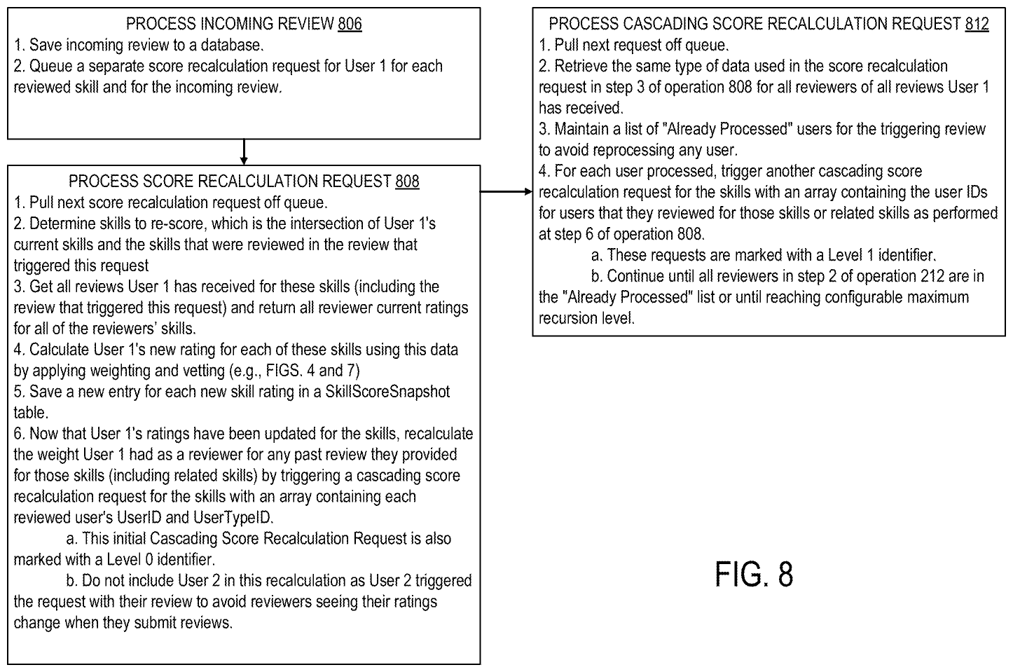

In the preceding example of FIG. 5, an example process 500 is described that can be performed by the system disclosed herein. FIG. 8 schematically depicts additional examples of processing that can be performed by the system disclosed herein in place of or in combination with the previously described operations of FIG. 4.

FIG. 8 depicts operation 806 in which an incoming new review for a target user by a reviewer is processed. Operation 806 can replace previously described operation 506 of FIG. 5 in at least some implementations. The incoming new review can be referred to as a triggering review that triggers operations 806, 808, and 812 to be performed by the system. The incoming new review can be obtained synchronously with submission by a reviewer as previously described with reference to FIG. 5. As part of operation 806, the incoming review is saved to a database, and a score recalculation request is queued for the target user (e.g., User 1) for each reviewed skill of the target user and for the incoming review as the triggering review. The score recalculation request can be performed asynchronously as previously described with reference to FIG. 5.

FIG. 8 further depicts operation 808 in which the score recalculation request is processed by the system. Operation 808 can replace previously described operation 508 of FIG. 5 in at least some implementations. As part of processing the score recalculation request at 808, the next score recalculation request can be pulled off the queue. The score recalculation request can be processed asynchronously as previously described with reference to FIG. 5.

The system determines the skills to re-score, which is the intersection of the target user's (e.g., User 1) current skills and the skills that were reviewed in the review that triggered the score recalculation request being processed. The system retrieves all reviews the target user (e.g., User 1) has received for the skills to be re-scored, including the review that triggered the score recalculation request, and the system returns, for each of the reviewers of the target user, all reviewer current ratings for all of the reviewer's skills. The system calculates the target user's (e.g., User 1) new rating for each of the skills using the data retrieved at step 3 of operation 808 by applying weighting and vetting as previously described with reference to FIGS. 4 and/or 7. The system saves a new entry for each new skill rating for the target user in a SkillScoreSnapshot table. Now that the target user's (e.g., User 1) ratings have been updated for the skills, the system recalculates the weight the target user (e.g., User 1) had as a reviewer for any past review they provided for those skills and for related skills, as previously described with reference to FIGS. 4 and/or 7, by triggering a cascading score recalculation request for the skills within an array containing each reviewed user's UserlD and UserTypelD. The initial cascading score recalculation request is marked with a Level 0 identifier to indicate that the request has be fulfilled with respect to the target user. The reviewer (e.g., User 2) that submitted the review that triggered the score recalculation request is not included in the recalculation performed at step 6 of operation 808, for example, to avoid reviewers seeing their rating change when they submit reviews.

FIG. 8 further depicts operation 812 in which the cascading score recalculation request triggered at step 6 of operation 808 is processed by the system. Operation 812 can replace previously described operation 512 of FIG. 5 in at least some implementations. As part of processing the cascading score recalculation request at 812, the next cascading score recalculation request can be pulled off the queue. The cascading score recalculation request can be processed asynchronously as previously described with reference to FIG. 5.

The system retrieves the same type of data used in the score recalculation request in step 3 of operation 808 for all reviewers of all reviews for the target user (e.g., User 1). The system maintains a list of “Already Processed” users for triggering review to avoid reprocessing any user. For each user processed, the system triggers another cascading score recalculation request for the skills within an array containing the user IDs for users that they reviewed for those skills or for related skills as performed at step 6 of operation 808. The cascading score recalculation requests are marked with a Level 1 identifier indicating that the users are reviewers of the target user of the triggering review. The system continues processing the cascading score recalculation requests until all reviewers in step 2 of operation 212 are in the “Already Processed” list or until reaching a configurable maximum recursion level. This maximum recursion level can be set at any suitable level by system administrators according to processing resource constraints and/or processing time constraints.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic subsystem 902 and a storage subsystem 904. Computing system 900 may optionally include a display subsystem 908, input subsystem 910, communication subsystem 912, and/or other components not shown in FIG. 9.

Logic subsystem 902 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic machines configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 904 includes one or more physical devices configured to hold instructions executable by the logic subsystem to implement the methods and processes described herein. When such methods and processes are implemented, the state of storage subsystem 904 may be transformed—e.g., to hold different data.

Storage subsystem 904 may include removable and/or built-in devices. Storage subsystem 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 904 may include volatile, nonvolatile, dynamic, static, read/write, read-only, random-access, sequential-access, location-addressable, file-addressable, and/or content-addressable devices.

It will be appreciated that storage subsystem 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 902 and storage subsystem 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic subsystem 902 executing instructions held by storage subsystem 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 908 may be used to present a visual representation of data held by storage subsystem 904. This visual representation may take the form of a graphical user interface (GUI). As the herein described methods and processes change the data held by the storage subsystem, and thus transform the state of the storage subsystem, the state of display subsystem 908 may likewise be transformed to visually represent changes in the underlying data. Display subsystem 908 may include one or more display devices utilizing virtually any type of technology. Such display devices may be combined with logic subsystem 902 and/or storage subsystem 904 in a shared enclosure, or such display devices may be peripheral display devices.

When included, input subsystem 910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 912 may be configured to communicatively couple computing system 900 with one or more other computing devices. Communication subsystem 912 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

According to an example of the present disclosure, a method performed by a computing system comprises: upon detecting a condition, obtaining one or more ratings of a primary skill of a user, each of the one or more ratings being made by a respective reviewer; for one or more respective reviewers, obtaining one or more ratings of one or more skills of the respective reviewer; and based at least on the one or more ratings of the primary skill of the user and the one or more ratings of the one or more skills of the respective reviewers, determining a computed rating of the primary skill of the user. In this example or other examples disclosed herein, the method further comprises: weighting each of the one or more ratings of the primary skill based on an age of the rating; wherein the computed rating of the primary skill of the user is based on the weighting of each of the one or more ratings of the primary skill. In this example or other examples disclosed herein, the method further comprises: weighting each of the one or more ratings of the primary skill based on a standard deviation of the rating; wherein the computed rating of the primary skill of the user is based on the weighting of each of the one or more ratings of the primary skill. In this example or other examples disclosed herein, the method further comprises: weighting each of the one or more ratings of the primary skill based on the reviewer that made the rating being rated on the primary skill; wherein the computed rating of the primary skill of the user is based on the weighting of each of the one or more ratings of the primary skill. In this example or other examples disclosed herein, the method further comprises: weighting each of the one or more ratings of the primary skill based on the reviewer that made the rating being rated on a skill that is related to or unrelated to the primary skill; wherein the computed rating of the primary skill of the user is based on the weighting of each of the one or more ratings of the primary skill. In this example or other examples disclosed herein, the computed rating of the primary skill includes a rating of the primary skill at a selected skill level of a plurality of skill levels, and the method further comprises determining a computed rating of the primary skill of the user at another skill level of the plurality of skill levels other than the selected skill level. In this example or other examples disclosed herein, determining the computed rating of the primary skill of the user at the other skill level comprises applying a skill level adjustment to the computed rating of the primary skill at the selected skill level. In this example or other examples disclosed herein, the condition includes receiving a new rating of the primary skill of the user; and wherein the computed rating of the primary skill of the user is determined further based on the new rating of the primary skill of the user. In this example or other examples disclosed herein, determining the computed rating of the primary skill of the user is further based on a self-assessed skill level of the user for the primary skill as compared to a skill level of the user identified by each respective reviewer. In this example or other examples disclosed herein, the method further comprises: comparing a quantity of the ratings of the primary skill of the user made by the respective reviewers to a minimum quantity threshold; and publishing the computed rating of the primary skill of the user at a network resource accessible to other users responsive to the quantity of the ratings attaining or exceeding the minimum quantity threshold. In this example or other examples disclosed herein, the method further comprises: comparing, to a minimum ratio threshold greater than 1.0, a ratio of a quantity of ratings made by other reviewers for the respective reviewers to a quantity of the ratings of the primary skill of the user made by the respective reviewers; and publishing the computed rating of the primary skill of the user at a network resource accessible to other users responsive to the ratio attaining or exceeding the minimum ratio threshold.

According to an example of the present disclosure, a computing system comprises: a logic subsystem of one or more logic devices; and a storage subsystem of one or more storage devices having instructions stored thereon that are executable by the logic subsystem to: upon detecting a condition, obtain one or more ratings of a primary skill of a user, each of the one or more ratings being made by a respective reviewer; for one or more respective reviewers, obtain one or more ratings of one or more skills of the respective reviewer; and based at least on the one or more ratings of the primary skill of the user and the one or more ratings of the one or more skills of the respective reviewers, determine a computed rating of the primary skill of the user. In this example or other examples disclosed herein, the instructions are further executable by the logic subsystem to: weight each of the one or more ratings of the primary skill based on one or more of: an age of the rating, a standard deviation of the rating, the reviewer that made the rating being rated on the primary skill, the reviewer that made the rating being rated on a skill that is related to the primary skill, the reviewer that made the rating being rated on a skill that is unrelated to the primary skill; and wherein the computed rating of the primary skill of the user is based on the weighting of each of the one or more ratings of the primary skill. In this example or other examples disclosed herein, the computed rating of the primary skill includes a rating of the primary skill at a selected skill level of a plurality of skill levels; and wherein the instructions are further executable by the logic subsystem to determine a computed rating of the primary skill of the user at another skill level of the plurality of skill levels other than the selected skill level. In this example or other examples disclosed herein, the computed rating of the primary skill of the user at the other skill level is determined by the logic subsystem applying a skill level adjustment to the computed rating of the primary skill at the selected skill level. In this example or other examples disclosed herein, the condition includes the computing system receiving a new rating of the primary skill of the user; and wherein the computed rating of the primary skill of the user is determined further based on the new rating of the primary skill of the user. In this example or other examples disclosed herein, the computed rating of the primary skill of the user is determined further based on a self-assessed skill level of the user for the primary skill as compared to a skill level of the user identified by each respective reviewer. In this example or other examples disclosed herein, the instructions are further executable by the logic subsystem to: compare a quantity of the ratings of the primary skill of the user made by the respective reviewers to a minimum quantity threshold; and publish the computed rating of the primary skill of the user at a network resource accessible to other users responsive to the quantity of the ratings attaining or exceeding the minimum quantity threshold. In this example or other examples disclosed herein, the instructions are further executable by the logic subsystem to: compare, to a minimum ratio threshold greater than 1.0, a ratio of a quantity of ratings made by other reviewers for the respective reviewers to a quantity of the ratings of the primary skill of the user made by the respective reviewers; and publish the computed rating of the primary skill of the user at a network resource accessible to other users responsive to the ratio attaining or exceeding the minimum ratio threshold.

According to an example of the present disclosure, an article of manufacture comprises: a storage subsystem of one or more storage devices having instructions stored thereon that are executable by a computing system to: upon receiving a new rating of a primary skill of a user, obtain one or more other ratings of the primary skill of the user, each of the new rating and the one or more other ratings being made by a respective reviewer; for one or more respective reviewers, obtain one or more ratings of one or more skills of the respective reviewer; and based at least on the new rating of the primary skill of the user, the one or more other ratings of the primary skill of the user, and the one or more ratings of the one or more skills of the respective reviewers, determine a computed rating of the primary skill of the user.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method performed by a computing system, the method comprising:
upon detecting a condition, obtaining one or more ratings of a primary skill of a user, each of the one or more ratings being made by a respective reviewer;
for one or more respective reviewers, obtaining one or more ratings of one or more skills of the respective reviewer; and
based at least on the one or more ratings of the primary skill of the user and the one or more ratings of the one or more skills of the respective reviewers, determining a computed rating of the primary skill of the user.

2. The method of claim 1, further comprising weighting each of the one or more ratings of the primary skill based on an age of the rating;
wherein the computed rating of the primary skill of the user is based on the weighting of each of the one or more ratings of the primary skill.

3. The method of claim 1, further comprising weighting each of the one or more ratings of the primary skill based on a standard deviation of the rating;
wherein the computed rating of the primary skill of the user is based on the weighting of each of the one or more ratings of the primary skill.

4. The method of claim 1, further comprising weighting each of the one or more ratings of the primary skill based on the reviewer that made the rating being rated on the primary skill;
wherein the computed rating of the primary skill of the user is based on the weighting of each of the one or more ratings of the primary skill.

5. The method of claim 1, further comprising weighting each of the one or more ratings of the primary skill based on the reviewer that made the rating being rated on a skill that is related to or unrelated to the primary skill;
wherein the computed rating of the primary skill of the user is based on the weighting of each of the one or more ratings of the primary skill.

6. The method of claim 1, where the computed rating of the primary skill includes a rating of the primary skill at a selected skill level of a plurality of skill levels, the method further comprising determining a computed rating of the primary skill of the user at another skill level of the plurality of skill levels other than the selected skill level.

7. The method of claim 6, where determining the computed rating of the primary skill of the user at the other skill level comprises applying a skill level adjustment to the computed rating of the primary skill at the selected skill level.

8. The method of claim 1, where the condition includes receiving a new rating of the primary skill of the user; and
wherein the computed rating of the primary skill of the user is determined further based on the new rating of the primary skill of the user.

9. The method of claim 1, wherein determining the computed rating of the primary skill of the user is further based on a self-assessed skill level of the user for the primary skill as compared to a skill level of the user identified by each respective reviewer.

10. The method of claim 1, further comprising:
comparing a quantity of the ratings of the primary skill of the user made by the respective reviewers to a minimum quantity threshold; and
publishing the computed rating of the primary skill of the user at a network resource accessible to other users responsive to the quantity of the ratings attaining or exceeding the minimum quantity threshold.

11. The method of claim 1, further comprising:
comparing, to a minimum ratio threshold greater than 1.0, a ratio of a quantity of ratings made by other reviewers for the respective reviewers to a quantity of the ratings of the primary skill of the user made by the respective reviewers; and
publishing the computed rating of the primary skill of the user at a network resource accessible to other users responsive to the ratio attaining or exceeding the minimum ratio threshold.

12. A computing system, comprising:
a logic subsystem of one or more logic devices; and
a storage subsystem of one or more storage devices having instructions stored thereon that are executable by the logic subsystem to:
upon detecting a condition, obtain one or more ratings of a primary skill of a user, each of the one or more ratings being made by a respective reviewer;
for one or more respective reviewers, obtain one or more ratings of one or more skills of the respective reviewer; and
based at least on the one or more ratings of the primary skill of the user and the one or more ratings of the one or more skills of the respective reviewers, determine a computed rating of the primary skill of the user.

13. The computing system of claim 12, wherein the instructions are further executable by the logic subsystem to:
weight each of the one or more ratings of the primary skill based on one or more of:
an age of the rating,
a standard deviation of the rating,
the reviewer that made the rating being rated on the primary skill,
the reviewer that made the rating being rated on a skill that is related to the primary skill,
the reviewer that made the rating being rated on a skill that is unrelated to the primary skill; and
wherein the computed rating of the primary skill of the user is based on the weighting of each of the one or more ratings of the primary skill.

14. The computing system of claim 12, where the computed rating of the primary skill includes a rating of the primary skill at a selected skill level of a plurality of skill levels; and
wherein the instructions are further executable by the logic subsystem to determine a computed rating of the primary skill of the user at another skill level of the plurality of skill levels other than the selected skill level.

15. The computing system of claim 14, where the computed rating of the primary skill of the user at the other skill level is determined by the logic subsystem applying a skill level adjustment to the computed rating of the primary skill at the selected skill level.

16. The computing system of claim 12, where the condition includes the computing system receiving a new rating of the primary skill of the user; and
wherein the computed rating of the primary skill of the user is determined further based on the new rating of the primary skill of the user.

17. The computing system of claim 12, wherein the computed rating of the primary skill of the user is determined further based on a self-assessed skill level of the user for the primary skill as compared to a skill level of the user identified by each respective reviewer.

18. The computing system of claim 12, wherein the instructions are further executable by the logic subsystem to:
compare a quantity of the ratings of the primary skill of the user made by the respective reviewers to a minimum quantity threshold; and
publish the computed rating of the primary skill of the user at a network resource accessible to other users responsive to the quantity of the ratings attaining or exceeding the minimum quantity threshold.

19. The computing system of claim 12, wherein the instructions are further executable by the logic subsystem to:
compare, to a minimum ratio threshold greater than 1.0, a ratio of a quantity of ratings made by other reviewers for the respective reviewers to a quantity of the ratings of the primary skill of the user made by the respective reviewers; and
publish the computed rating of the primary skill of the user at a network resource accessible to other users responsive to the ratio attaining or exceeding the minimum ratio threshold.

20. An article of manufacture, comprising:
a storage subsystem of one or more storage devices having instructions stored thereon that are executable by a computing system to:
upon receiving a new rating of a primary skill of a user, obtain one or more other ratings of the primary skill of the user, each of the new rating and the one or more other ratings being made by a respective reviewer;
for one or more respective reviewers, obtain one or more ratings of one or more skills of the respective reviewer; and
based at least on the new rating of the primary skill of the user, the one or more other ratings of the primary skill of the user, and the one or more ratings of the one or more skills of the respective reviewers, determine a computed rating of the primary skill of the user.
